(19) United States
(12) Patent Application Publication
(10) Pub. No.: US 2026/0344578 A1
(43) Pub. Date: Nov. 5, 2026

(54) Hanging Barrel Plant Holder

(71) Applicants: Derrick Livengood, Delta Junction, AK (US); Danielle Livengood, Delta Junction, AK (US)

(72) Inventors: Derrick Livengood, Delta Junction, AK (US); Danielle Livengood, Delta Junction, AK (US)

(21) Appl. No.: 19/664,289

(22) Filed: Apr. 30, 2026

Related U.S. Application Data
(60) Provisional application No. 63/797,687, filed on Apr. 30, 2025.

(51) Int. Cl. A01G 9/02; A01G 9/12; A01G 27/00

(52) U.S. Cl. CPC A01G 9/0302; A01G 9/12; A01G 27/003

(57) ABSTRACT

A hanging barrel plant holder configured to support and display plants while enhancing aesthetic appeal and functionality. The hanging barrel plant holder includes a locking barrel container having a top portion and a bottom portion coupled via a locking groove system, and a locking base cradle configured to support the container and retain soil and plant material. A plurality of holes are provided to receive plants while rope grooves secure a surrounding rope for suspension and structural integrity. The rope grooves are sized to hold a rope in place when the barrel is not in a hanging position. A water and fertilizer delivery system includes one or more water spikes and a fertilizer spike configured to deliver water and fertilizer directly to central and lower regions of the barrel. A removable locking base provides stability when the hanging barrel plant holder is placed on a surface or being shipped. A removable plant support attachment assists in maintaining plant shape and preventing stem damage.

### CROSS-REFERENCE TO RELATED APPLICATIONS

This is a U.S. Non-Provisional Patent Application that claims the benefit of U.S. Provisional Patent Application No. 63/797,687 filed Apr. 30, 2025, which is incorporated herein by reference in its entirety.

### BACKGROUND OF THE INVENTION

The present invention is related to a plant holder. More specifically, the present invention is related to a hanging barrel plant holder.

Plants add a lot to an environment, whether they are hung outside or inside. A plant container may add to the aesthetics of the plant.

What is needed is a hanging barrel plant holder that contains a plant and provides additional aesthetic qualities to the plant.

### SUMMARY OF THE INVENTION

In view of the foregoing disadvantages inherent in the known types of hanging barrel plant holders now present in the prior art, the present invention provides a hanging barrel plant holder wherein the same may contain a plant and provide additional aesthetic qualities to the plant.

The present invention is related to a plant holder. More specifically, the present invention is related to a hanging barrel plant holder.

The hanging barrel plant holder comprises a barrel-shaped container and an elongated container cradle, a locking barrel container having a top portion and a bottom portion, a removeable plant support attachment locked in place to support any plants in the locking barrel container, a water and fertilizer delivery system designed to deliver water and fertilizer to the center of the locking barrel container, and a locking base disposed on the bottom portion of the locking barrel container.

The hanging barrel plant holder includes a top portion and a bottom portion that are able to be split in half allowing a root wad to be easily removed.

An object of the present invention is to provide a hanging barrel plant holder that contains a plant and provides additional aesthetic qualities to the plant.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of a hanging barrel plant holder.

FIG. 2 shows a perspective view a hanging barrel plant holder in an unassembled position.

FIG. 3 shows a bottom perspective view of a bottom portion of a hanging barrel plant holder.

FIG. 4 shows a perspective view of a locking base of a hanging barrel plant holder.

FIG. 5 shows an open sectional side perspective view of a hanging barrel plant holder.

FIG. 6 shows a perspective view of a water and fertilizer delivery system of a hanging barrel plant holder.

FIG. 7 shows a bottom view of a removeable plant support attachment of a hanging barrel plant holder.

### DETAILED DESCRIPTION OF THE INVENTION

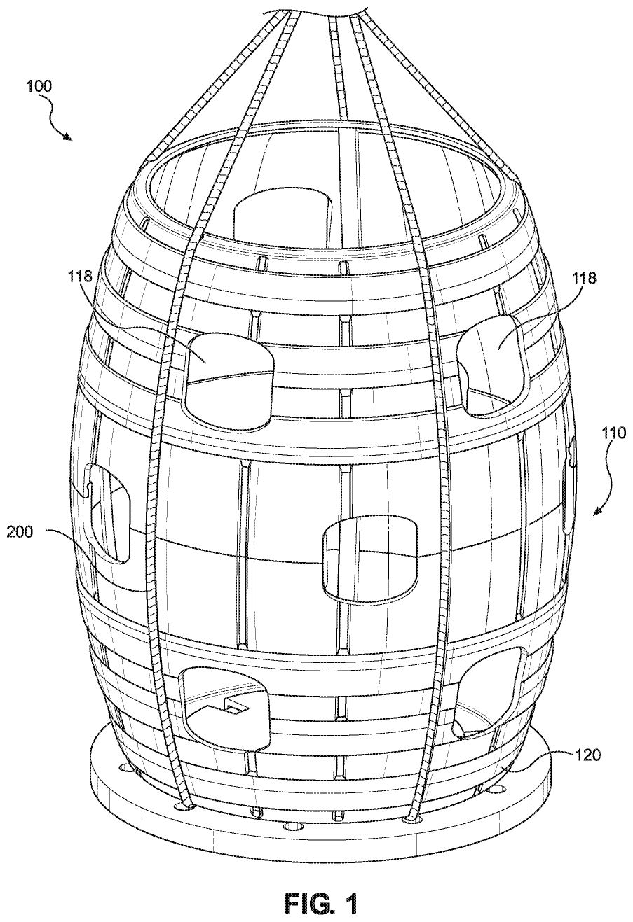

FIG. 1 shows a front perspective view of a hanging barrel plant holder 100.

The hanging barrel plant holder 100 may include a locking barrel container 110 and a locking base cradle 120.

The locking barrel container 110 may include a plurality of holes 118 to receive a plant and are designed with sufficient room for air to prevent root rot and with a shape that will accommodate the removeable plant support attachment 180 that may be locked in place to support any plants in the locking barrel container 110.

The hanging barrel plant holder includes a plurality of rope grooves 118A disposed on the hanging barrel plant holder 100 and are designed and adapted to hold a rope 200 in place around the locking barrel container 110 and secure the rope 200 when the barrel is not in a hanging position.

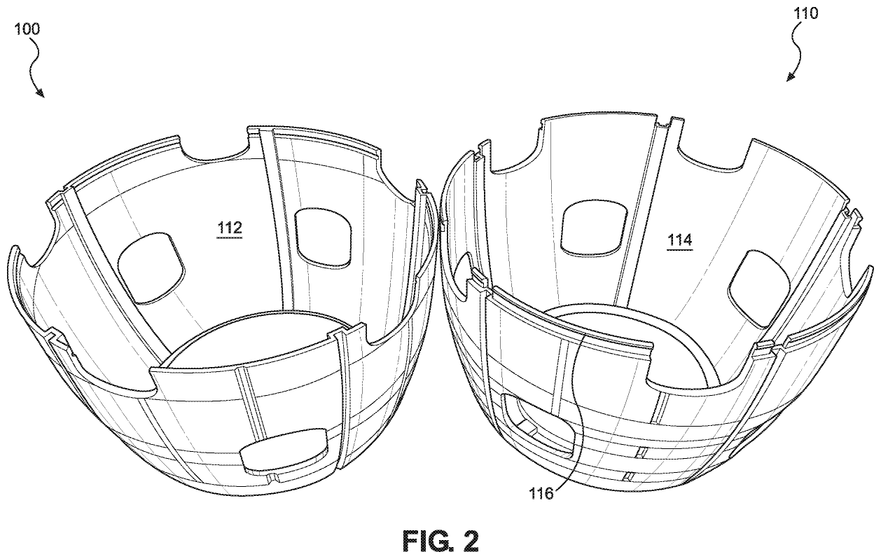

FIG. 2 shows a perspective view a hanging barrel plant holder in an unassembled position.

The locking barrel container 110 may include a top portion 112 and a bottom portion 114. The top portion 112 may be coupled to the bottom portion 114 with a locking groove system 116 disposed on the upper edge of the top portion 112 and the bottom portion 114.

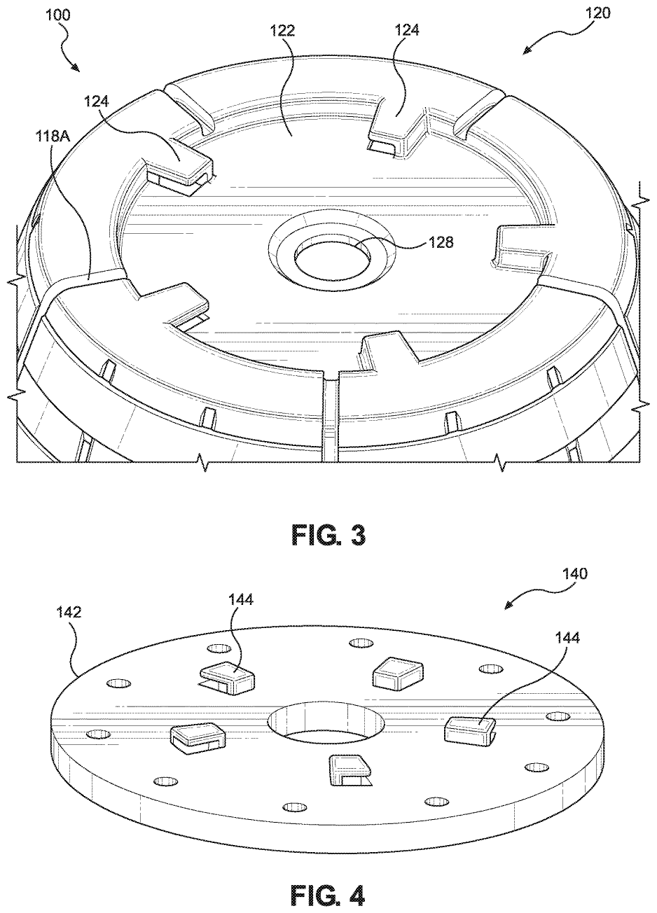

FIG. 3 shows a bottom perspective view of a bottom portion of a hanging barrel plant holder.

The hanging barrel plant holder 100 may include a locking base cradle 120.

The locking base cradle 120 may include a recessed circular portion 122, a plurality of raised tabs and apertures 124, and a first centered aperture 128.

The recessed circular portion 122 may be disposed and centered on the locking base cradle 120. The plurality of raised tabs and apertures 124 may be disposed on the recessed circular portion 122 and its circumference and may be equidistance spaced along the circumference of the recessed circular portion 122. The rope grooves 118A are disposed on the hanging barrel plant holder 100 and are designed to hold the rope 200 in place around the locking barrel container 110 and secure the rope 200 when the barrel is not in a hanging position. The first centered aperture 128 may correspond to a second centered aperture and a plurality of corresponding fitted apertures 144 on a locking base 140 that may be removably secured to the bottom surface of the bottom portion 114 of the locking barrel container 110.

The locking base cradle 120 may include a rope 200 that is wrapped all around the locking barrel container 110 to hold the locking barrel container 110 together. The rope 200 may be made of a durable material such as twine, hemp or the like.

FIG. 4 shows a perspective view of a locking base of a hanging barrel plant holder.

The locking base 140 may include a planar base 142 and a plurality of corresponding fitted apertures 144.

The planar base 142 may be coupled to the locking base cradle 120 of the hanging barrel plant holder 100. The plurality of corresponding fitted apertures 144 may directly correspond to the raised tabs and apertures 124 to more specifically couple the planar base 142 to the locking base cradle 120.

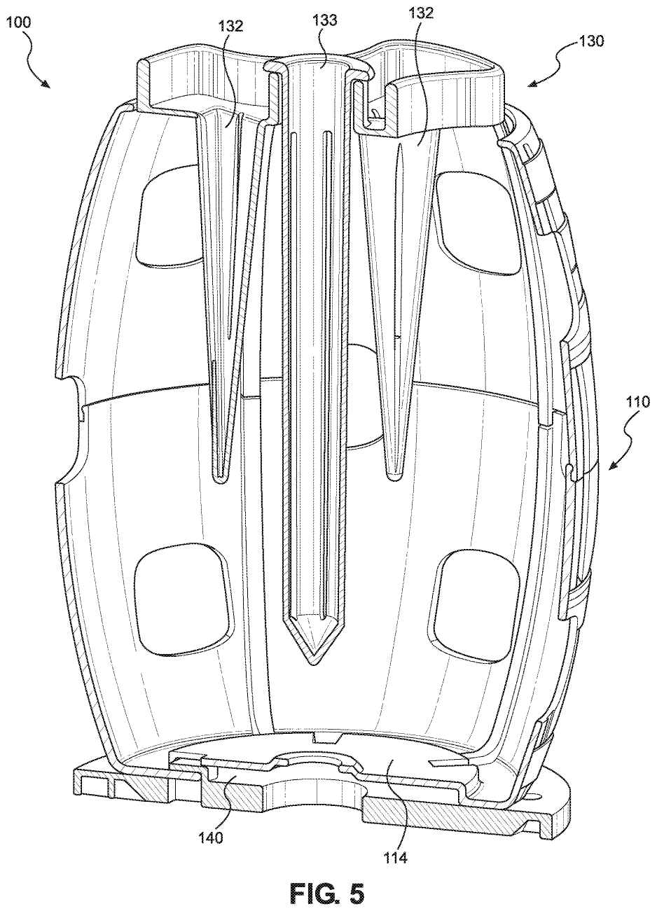

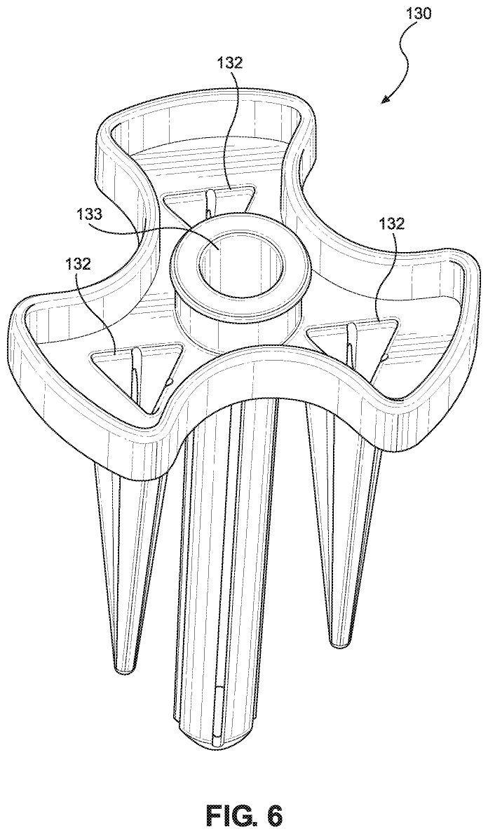

FIG. 5 shows an open sectional side perspective view of a hanging barrel plant holder.

FIG. 6 shows a perspective view of a water and fertilizer delivery system of a hanging barrel plant holder.

The hanging barrel plant holder 100 may include a water and fertilizer delivery system 130 and a locking base 140.

The water and fertilizer delivery system 130 may include a plurality of water spikes 132 designed to deliver water to the center of the locking barrel container 110 where it would otherwise be very hard to get to. The plurality of water spikes 132 deliver water to the middle portion of the locking barrel container 110 and help to maximize the absorption of water by increasing the surface area of the dirt within the hanging barrel plant holder receiving water.

The water and fertilizer delivery system 130 may also include a fertilizer spike 133 used to make a hole leading to the bottom of a plant designed to deliver solid fertilizers to the bottom of a plant disposed within the locking barrel container 110 that would be otherwise very hard to get to. The fertilizer spike 133 may be removed from the locking barrel container 110 or left in the locking barrel container 110 depending on the type of fertilizer being used on the plant within the hanging barrel plant holder 100.

The locking base 140 may be disposed on the bottom portion 114 of the locking barrel container 110 when the locking barrel container 110 is placed on surface such as a deck or a railing to keep animals or wind from knocking the locking barrel container 110 over.

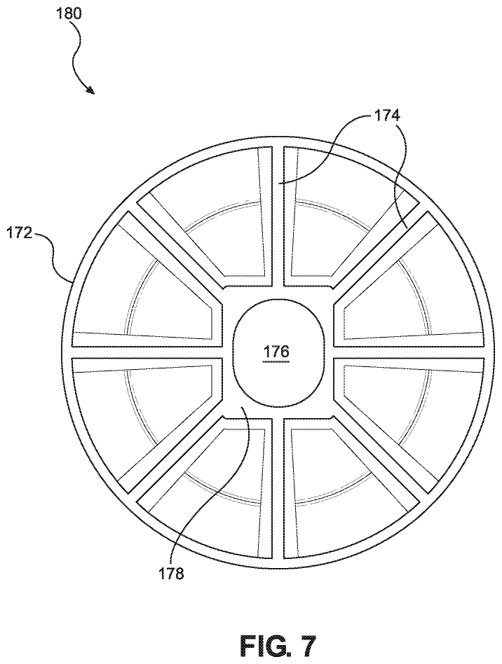

FIG. 7 shows a bottom view of a removeable plant support attachment of a hanging barrel plant holder.

The removable plant support attachment 180 may include a linear circular frame 172, a plurality of linear supports 174, and a centered aperture 176 that may help a plant hold its desired form and prevent plant stems from breaking at the base of the plant.

The centered aperture 176 may include a square shaped perimeter 178 disposed around the centered aperture 176 to provide additional structural strength and support to the centered aperture 176.

It is therefore submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, and assembly and use, are deemed readily apparent and obvious to one skilled in the art, and all equivalent relationships to those illustrated in the drawings and described in the specification are intended to be encompassed by the present invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A hanging barrel plant holder, comprising:
a locking barrel container having a top portion and a bottom portion;
a locking base cradle locked in place to support any plants in the locking barrel container;
a water and fertilizer delivery system designed to deliver water and fertilizer to the center of the locking barrel container; and
a locking base disposed on the bottom portion of the locking barrel container.

2. The hanging barrel plant holder, according to claim 1, further comprising a plurality of holes to receive a plant designed with sufficient room for air to prevent root rot.

3. The hanging barrel plant holder, according to claim 2, wherein the locking barrel container includes a plurality of rope grooves disposed on the outer portion of the barrel that are designed and adapted to hold a rope in place around the locking barrel container and secure the rope when the barrel is not in a hanging position.

4. The hanging barrel plant holder, according to claim 1, wherein the top portion is coupled to the bottom portion with a locking groove system disposed on the upper edge of the top portion and the bottom portion.

5. The hanging barrel plant holder, according to claim 1, wherein the locking base cradle includes a recessed circular portion, a plurality of raised tabs and apertures, and a centered aperture.

6. The hanging barrel plant holder, according to claim 5, wherein the recessed circular portion is disposed and centered on the locking base cradle.

7. The hanging barrel plant holder, according to claim 5, wherein the raised tabs and apertures are disposed across the recessed circular portion and its circumference and are equidistance spaced along the circumference of the recessed circular portion.

8. The hanging barrel plant holder, according to claim 5, wherein the centered aperture corresponds to a centered aperture disposed on a bottom surface of the bottom portion to accommodate an object or material extending through the centered aperture of the locking base cradle and the centered aperture disposed on the bottom surface of the bottom portion.

9. The hanging barrel plant holder, according to claim 3, wherein the locking base cradle includes the rope that is wrapped all around the locking barrel container to hold the locking barrel container together.

10. The hanging barrel plant holder, according to claim 5, wherein the centered aperture aligns with the centered aperture disposed on the bottom surface of the bottom portion.

11. The hanging barrel plant holder, according to claim 1, wherein the locking base includes a planar base and a plurality of corresponding fitted apertures.

12. The hanging barrel plant holder, according to claim 11, wherein the planar base is coupled to the locking base cradle of the hanging barrel plant holder.

13. The hanging barrel plant holder, according to claim 11, wherein the plurality of corresponding fitted apertures directly correspond to the raised tabs and apertures to more specifically couple the planar base to the locking base cradle.

14. The hanging barrel plant holder, according to claim 1, wherein the water and fertilizer delivery system includes a plurality of water spikes designed to deliver water to the center of the locking barrel container.

15. The hanging barrel plant holder, according to claim 1, wherein the water and fertilizer delivery system includes a fertilizer spike designed to deliver solid fertilizers to the bottom of a plant disposed within the locking barrel container.

16. The hanging barrel plant holder, according to claim 1, wherein the locking base is disposed on the bottom portion of the locking barrel container when the locking barrel container is placed on a surface to keep animals or wind from knocking the locking barrel container over.

17. The hanging barrel plant holder, according to claim 1, further comprising a removeable plant support attachment that may include a linear circular frame, a plurality of linear supports, and a centered aperture.
